(19) United States
(12) Patent Application Publication
(10) Pub. No.: US 2020/0183140 A1
(43) Pub. Date: Jun. 11, 2020

(54) DUAL PARALLEL OPTICAL AXIS MODULES SHARING SAMPLE STAGE FOR BIOBURDEN TESTING

(71) Applicant: ReaMetrix, Inc., Fremont, CA (US)

(72) Inventor: Bala S. Manian, Los Altos Hills, CA (US)

(73) Assignee: ReaMetrix, Inc., Fremont, CA (US)

(21) Appl. No.: 16/710,264

(22) Filed: Dec. 11, 2019

Related U.S. Application Data
(60) Provisional application No. 62/777,938, filed on Dec. 11, 2018.

(51) Int. Cl. G02B 21/00; G01N 21/64; G02B 21/36

(52) U.S. Cl. CPC G02B 21/0076; G02B 21/06; G02B 21/365; G01N 21/6458

(57) ABSTRACT

Filter membranes and the like carrying fluorescent targets suspected of being bioburden are tested by mounting the membranes on a sample holder within a cabinet for bioburden verification and discrimination from false positives. Fluorescence is excited by a fluorescence excitation module having a first optical axis perpendicular to the sample, with three dimension locations of fluorescent targets that are probable bioburden stored for use by a microscope imaging module having a second optical axis parallel to the first optical axis, with dual wavelength illumination for autofocus and then for stimulating fluorescence without photo bleaching of the targets. The probable bioburden targets are moved for inspection and identification in the microscope imaging module as bioburden or not by sharing a common sample holder in the cabinet.

### CROSS-REFERENCE TO RELATED APPLICATION

This application claims priority under 35 U.S.C. 119(e) from prior U.S. provisional application 62/777,938, filed Dec. 11, 2018.

### TECHNICAL FIELD

The invention relates to sterility and bioburden testing of fluorescent samples and, more particularly, to rapid fluorescent analysis of filter membranes or flat fluid samples for sterility and bioburden testing.

### BACKGROUND ART

In the pharmaceutical industry, quality control laboratories are monitoring sterility or bioburden in non-sterile fluids under strong pressure to reduce the time for testing microbiological contamination due to increasing demands for fast results. Prior art use of standard agar growth plates for detection and enumeration of bacteria and the like typically takes 3-5 days.

In order to improve the ability to detect non-sterile conditions, manufacturers have looked towards new technologies to reduce the time for sample analysis. Nevertheless, the main challenge is not to only produce a quicker method of analysis, but also to ensure that the sensitivity of detection is maximized, i.e, the technology has the ability to detect very low levels of microorganisms, even down to a single bacterium for sterility testing. In the forefront of rapid methods development have been such techniques as bioluminescence, microscopy-based fluorescence, antibody labelling techniques and more recently, PCR-based technologies.

In order to address the need for a truly rapid assay with a high level of sensitivity, a fluorescent tagging and scanning system is described in EU application EP 0713087, assigned to Chemunex, published in 1996, based on direct fluorescent labelling of microorganisms, coupled with a linear laser scanning and counting. A similar scanning system is described in U.S. Pat. No. 9,709,500 to Charles River Laboratories, Inc. and Reametrix, Inc. for “Optical Method for Detecting Viable Microorganisms in a Cell Sample”. A commercial version of this invention is called the “Immedia” filter scanner. A high level of sensitivity of the system allows the direct detection of a single cell and eliminates the need for cell growth and multiplication.

The Chemunex scanning system, called “ChemScan RDI” was used in microbial analysis, as described in the Interlaken '98 Conference, OECD Workshop entitled “Molecular Methods for Safe Drinking Water”. The Conference published report by P. Cornet et al. speaks of labelling and counting of microorganisms that are captured on filters scanned with a laser with fluorescence detected at 2 or 3 wavelengths. Results are displayed in the form of a scan map. The article indicates that subsequent visual examination of the sample is possible by microscopy, if required, by use of an automated microscope with a motor driven stage.

U.S. Pat. No. 9,669,406 entitled “Sample Assembly for a Measurement Device” by B. Manian et al. relates to a spinning sample carrier that advances the samples on a linearly movable platform as it spins. A round sample carrier holds circumferentially spaced filters that hold the sample fluid or filters under test.

Optical probing of samples by rotation and linear motion is known. See, for example, U.S. Pat. No. 7,858,382 to Y. Kim et al. for “Sensing Apparatus having Rotating Optical Assembly” featuring rotating optics with a linearly movable sample. Sample holders for filters and membranes capturing liquid samples are also known. See, for example, U.S. Pat. No. 9,745,546 to Aviles et al. for “Cassette for Sterility Testing”.

A problem that occurs in prior art assays based on fluorescence is false positive readings since background fluorescence is ubiquitous. An object of the invention is to develop a fast test or assay for sterility and bioburden, yet avoid false positives arising, for example, from non biological particles, such as chest or minerals in fluids that are part of background fluorescence.

### SUMMARY

The above object has been met with the discovery of a fluorescent target verification instrument that can be used to confirm the presence of bacteria amidst possible targets in a sample believed to be sterile. A cabinet contains a modular combination of a fluorescent excitation beam along a first optical axis and a microscope camera on a second parallel optical axis closely spaced to the first axis with both first and second parallel axes impinging on a shared sample carrier. The camera images a target for positive verification of a bacterium amidst false positives. The results can be used to measure the bioburden or number of bacteria in a particular sample of interest.

The two parallel optical axes are arranged in rigidly mounted modules placed side by side in a desktop cabinet that can be readily moved in a laboratory or manufacturing facility. The parallel optical axes operate on, i.e., share, the same rotating sample holder as the sample holder advances linearly. One module uses a beam on a first optical axis to create fluorescent illumination of tagged target bioburden with r,θ,z sample coordinates sequentially recorded from a sample scan for detailed inspection by the downstream microscope imaging module. This first scan uses a large beam spot and coarse focus. The downstream microscope imaging module has a second optical axis, parallel to the first axis, that images the location of the illuminated tagged bioburden and has fine focus. The module uses a first illumination source that avoids photo bleaching during autofocus and a second different light source to stimulate fluorescence for observation and sample analysis. The recorded sample and sample spectra coordinates from the first module in a first low resolution scan of a sample holder are used both for immediate target discrimination as well as for sample location by the second module and for later analysis and inspection of likely bioburden in order to identify species in a second scan of the sample holder at high resolution. The low resolution identification of probable bioburden targets speeds the detailed high resolution scan involving bioburden size and morphology.

### DESCRIPTION OF THE DRAWINGS

FIG. 1 is a simplified diagrammatic view of a fluorescence excitation module and a microscope imaging module having parallel optical axes impinging on a single spinning sample holder in accordance with the invention.

FIG. 2 is a block diagram of data operations in the apparatus of FIG. 1.

FIG. 3 is a perspective internal view of optical components of a microscope imaging module of FIG. 1 inside of a portable cabinet.

FIG. 4 is a perspective external view of the microscope imaging module of FIG. 3 within a frame supporting a rotating sample holder beneath the microscope imaging module

FIG. 5 is a top view of the frame shown in FIG. 3 with the microscope imaging module of FIG. 3 removed revealing the spinning sample holder below the microscope imaging module location.

FIG. 6 is a top view of the frame shown in FIG. 3 showing locations of the microscope imaging module of FIG. 3 and the fluorescence excitation module.

FIG. 7 is a simplified internal view of optics in the fluorescence excitation module in accordance with prior art U.S. Pat. No. 9,523,640 (FIG. 9) and U.S. Pat. No. 9,671,345 (FIG. 9).

FIG. 8 is a side internal view of the fluorescence excitation module of FIG. 7 with a frame supporting a rotating sample holder beneath the fluorescence excitation module.

FIG. 9 is a perspective view of a spinning sample holder of FIG. 1 in accordance with prior art U.S. Pat. No. 9,446,411.

### DETAILED DESCRIPTION

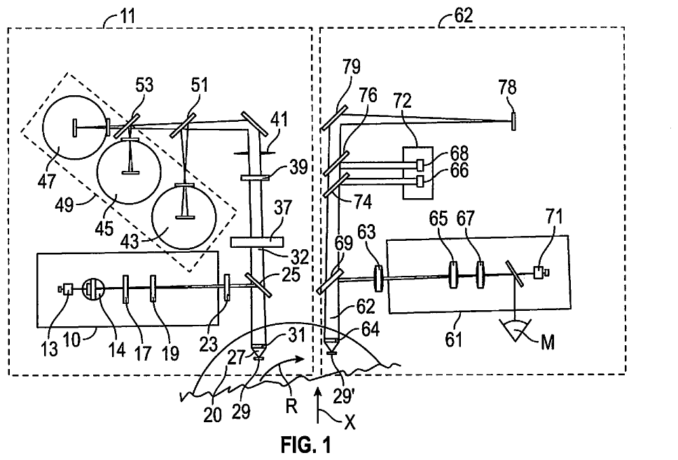

With reference to FIG. 1, a laser fluorescence excitation module 11 follows previously mentioned U.S. Pat. No. 9,709,500, incorporated by reference herein, and includes dual laser diode light source 13, having selectable laser diodes generating an incident beam on a sample carrier with wavelengths of between 480 nm to 500 nm at 12 mv and alternatively at 625 nm at 13 mv. This is followed by collimation optics 14, 17, 19 to produce a beam 21 having a diameter to impinge on the sample through collimator 23 and tilted glass plate 25. The beam yields a laser spot 27 of about 6 microns that defines a sample probe area 29 on the spinning sample carrier 20 for stimulating fluorescence along the first optical axis 32. The spot has a large depth of focus, say plus or minus 36 microns and the membrane does not have to be in perfect focus.

An excitation wavelength of 488 nm will excite fluorescence in sample material in a 30 nm band centered on 525 nm, 570 nm and 625 nm using three photomultiplier tube detectors 43, 45, 47. Instantaneous spectral data detection will establish whether the fluorescent target is probable bioburden, along with false positives present. If so established the wavelength of 480 nm may be used for determining an approximate Z coordinate of the target, with the r and θ coordinates being known from drive motor steps from known start positions. Coarse focus in the Z plane is acceptable for rapid scanning. The r,θ,Z coordinates of all probable bioburden as well as false positives are placed in a first data file described herein.

Scanning of the sample is achieved by rotation of the sample carrier 20, as indicated by arrow R, under the normally incident beam and not by tilting mirrors. Simultaneously the substrate is advanced in a linear direction, indicated by arrow X.

Sampling is done in steps by a step motor, with steps being about one-half the size of laser spot in the scan direction. There is coupling between rotational speed of the sample support and linear motion of the support assuring a continuous spiral scan over the sample holder with no gaps. Sampling appears as a matrix of points in the X and Y direction, although actually a spiral arc, but for closely spaced locations appears as a line. A selected laser is a CW laser diode but appears pulsed because fluorescent data is recorded at r, θ, z positions of each step where probable bioburden is sensed by detectors.

The invention uses a bacterium cell capture system as described in U.S. Pat. No. 9,709,500, mentioned above. Target samples are held in place on a fluid permeable, planar filter membrane comprising an exposed first surface, at least a portion of which is adapted to retain bacteria therein. That portion defines a plurality of pores having an average diameter less than about 1 μm so as to permit fluid to traverse the portion of the membrane while retaining bacteria and cells thereon. The membrane portion is substantially non-autofluorescent when exposed to light having a wavelength in a range from about 350 nm to about 1000 nm and has a flatness tolerance of up to about 100 μm.

The sample holder and filter membrane can be of any of a variety of shapes, for example, circular, annular, square, rectangular, elliptical, etc., and can have some portion or all of one side exposed for biomaterial retention. Alternatively, a sample holder may have one or more apertures therein to accommodate microfluidics and may be formed from several separate membranes assembled together with a mask or other structural element. The sample holder may be in the shape of a disc, for example, a substantially planar disc. A filter membrane can have a thickness in a range from 1 μm to 3,000 μm. The membrane must be fixed in place during sample processing as described herein.

Fluorescent targets within the sample are created with fluorescent tag particles or molecules conjugated with bacterial bioburden. The fluorescent tags are adapted to be excited by a beam of laser light having wavelengths as described above, but in any case in a range from about 350 nm to about 1000 nm. The fluorescent tags can be pre-disposed upon at least a portion of a filter membrane or otherwise conjugated with the bacteria. Alternatively, the fluorescent tags can be attached to the bacteria prior to passing the sample through the porous filter membrane. A filter membrane with trapped fluorescent targets is placed in a holder which is rigidly held by magnets or by a vacuum chuck or adhesive on a rotating platform driven by a spinner motor.

A beam of light from light source (excitation light) impinges on the rotating platform and the planar membrane disposed thereon, while emission light is detected by a detector, as shown in FIG. 1A of the '500 patent. The light source and the detector share a first optical axis. A beam incident on the sample will impact and leave the sample platform at the same angle. In certain circumstances, the detection system consists of a single detector that detects a single wavelength range or multiple wavelength ranges. Preferably, the detection system consists of multiple detectors, for example three detectors, each of which is capable of detecting a different wavelength range, say 525 nm, 570 nm and 625 nm.

A detailed description of the rotary laser sample platform is in U.S. Pat. Nos. 9,671,345 and 9,446,411, both incorporated by reference herein. Simultaneous with rotation, the rotary platform is slowly advanced in a linear motion, resulting in spiral scans over the entire surface of the membrane. Rotary and linear motions are coordinated so that resultant spiral scans encompass the entire area of sample holders.

The excitation module 11 can also include a power detector (not shown). The power detector is arranged to receive a portion of the laser beam which is split off by way of, for example, the tilted glass plate 25. The power detector can monitor the power of the laser beam and feed a signal back to the laser diodes 13 in order to stabilize the output of the laser diode such that it emits a consistent amount of light.

For establishing a fluorescent event, the emitted fluorescent signal from probe area 29 travels along the first optical axis 32 through glass plate 25, through collimating lens 37, a rejection filter 39 then through a pinhole 41 and then towards a series of photomultipliers (PMTs) 43, 45, 47 making up the photodetector subsystem 49 for simultaneous collection of fluorescent spectral data at different wavelengths. The pinhole 41 limits the depth of focus of the beam spot in a confocal manner to the sample surface, then directs the signal toward two beam splitters 51, 53. First beam splitter 51 is designed to reflect a signal in the range of about 650 nm to about 690 nm against the first PMT 43. Second beam splitter 53 is designed to reflect a signal in the range of about 690 nm to about 740 nm against the second PMT 45, while allowing a signal above about 750 nm to pass through to the third PMT 47.

Accordingly, the detector subsystem 49 can include a series of photosensitive detectors or PMTs all of which can read in the red and near infrared region. These PMTs, along with the components of the focusing and signal collection optics 100, provide the ability to divide a fluorescent signal emitted from the sample into different spectral regions or channels and are known in the art. In this manner, probable bioburden can be conducted simultaneously on a single sample through the use of a number of specific fluorescent tagging reagents for different type targets. For example, a first reagent can be added that emits a fluorescent signal that can be divided and then read by the first PMT 104, a second reagent can be added that emits a fluorescent signal that can be divided and then read by the second PMT 106, and so on. In this manner, a diode laser emitting at a particular wavelength (e.g. 488 nm) can be designed to excite a plurality of fluorophores, each specific to a certain type of bioburden target and each of which then each emits at a number of different fluorescent wavelengths that spectrally characterizes specific bioburden within probability limits.

Such an optically-defined measurement is fast for the location of any fluorescing targets within a predefined area which is relatively small but with a large beam spot size and only coarse focus. A Z-axis coordinate is approximated to localize a tagged target for three dimensional r,θ,Z coordinates. This may be achieved in alternative ways. A first way is use an appropriate laser beam wavelength to do a preview scan in one plane, recording r,θ coordinates for each fluorescent target. Then it is necessary to go back to each recorded coordinate and probe in the Z-direction for maximum fluorescence. Then record the r,θ,Z coordinate for each such location. Another way to proceed is to probe the Z direction as each r,θ coordinate for a fluorescent event is located, then record the r,θ,Z coordinate where maximum target fluorescence occurs.

When a fluorescent probable bioburden target is detected, the sample position in the r,θ,Z plane is recorded and the carrier is later rotated by a known amount to a microscope 61 in a microscope imaging module 62 where a tagged bioburden target on the shared spinning sample carrier 20 can be observed with precise focus and characterized as a bacterium or a false positive. In this manner sterility can be tested without confusion from false positive signals.

Once coordinates r,θ,Z are established in the first excitation module 11, a first data file is created and stored having multiple probable bioburden position points. The substrate can then be rotated using spinning sample carrier 20 by a fixed angle where a microscope 61 in the second module 62 has an objective 63 with 0.65 NA on a second optical axis 62, parallel to the first axis 32, is focused on sample 29′ at the recorded coordinates using the recorded coarse focus data to achieve precise focus and view bioburden size and morphology.

It is important that the first and second modules, as well as the sample holder be rigidly held in place to ensure reliability of the coordinate system that is shared across the modules. An observer, M, can view the tagged target along an extension of the second optical axis 62, parallel to the first optical axis 32 and through the microscope lenses 65, 67, tilted glass plate 69 and focus lens 64. A camera 71 records the fluorescent event for artificial intelligence target recognition. Comparing recorded pictures to images in a database of bioburden and particle images. Thus, each probable fluorescent bioburden target is characterized by a human M, or a camera 71, as bioburden or a false positive. The first and second optical axes, 32 and 62 respectively, are closely spaced by approximately a few centimeters so that the path between optical axes appears as a line, although in reality a spiral arc.

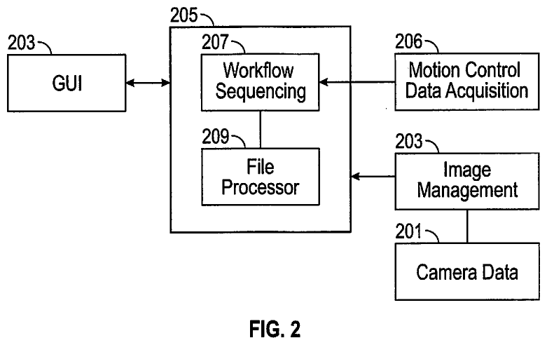

In operation, referring to FIG. 2, the first data file of the r,θ,z coordinates from motion control block 201 is sent to a graphical user interface or GUI 203 via computer 205 for visualization by an operator if desired. A workflow manager 207 sets up scans using the microscope module and scanner to obtain raw fluorescent scan background data that is transferred to the workflow manager where the information is stored in file processor 209. The workflow manager then points to stored fluorescent bioburden locations to apply any rules to the first data file in processor 209 that will reduce the data file. For example, rules defining optical spectral lines that define probable bioburden targets can separate out some false fluorescent positives, for example environmental or wear particles trapped in the membrane. The reduced data set is a second data file in processor 209 representing highly probable bioburden targets. This file is sent to the workflow manager 207. This data algorithm is carried out in the instrument cabinet that is dark in order to preserve fluorescence and avoid bleaching of targets.

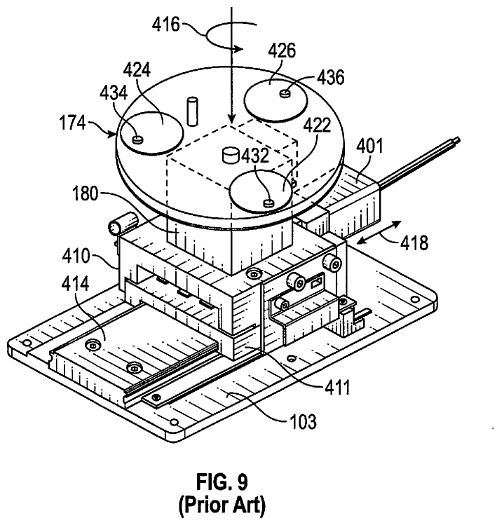

The workflow manager 207 then commands the scanner and microscope module to address points sequentially in the second data file. The scanner uses stepper motors to power a scan engine associated with motion control block 201 for simultaneous linear and rotational motion in the manner described in the '411 patent. The scan engine, shown and described with reference to FIG. 9, is commanded to sequentially go to the r,θ,z coordinates of probable bioburden position points of the second data file described above. For example, the workflow manager 207 sends instruction to the scan engine via motion control 201 to position the sample to a first position point from the second data file to be directly under the microscope module objective. Once under the microscope objective, with a numerical aperture of 0.65, image capture is initiated in a sequence. Image analysis may be by a human or by artificial intelligence associated with a camera that identifies bioburden, for example bacteria by shape, size and general pattern recognition. The scan engine confirms that the bioburden target point is in the commanded position.

Optical analysis camera operations on probable bioburden targets happens once the workflow manager initiates microscope imaging module sequential steps starting with focus. Returning to FIG. 1, first, a red LED 66 of light source 72 in the range of 480 nm to 500 nm, with a typical output power of 12 mW is directed toward dichroic mirror 74 and then to an initial point target 29′ from the second data file. Red light is used to prevent photo bleaching of the target that is stimulated to be fluorescent. The point target is located with the digital camera 71 for a focus sequence. A power monitor 78 on the second optical axis via mirror 79 adjusts power to the sources using a feedback loop.

A coarse focus is measured using total intensity over the central region where maximum fluorescent intensity of the bioburden point target is located. The maximum intensity position approximately defines the best focus position. The best focus position falls within a bracket defined by 80% of the peak intensity value. The peak intensity point becomes the seed position for the fine focus finding process. During this coarse focus hunting process, the vertical step movement of the focal point is of the order of 5 or 6 microns with a focal search over 250 microns. This leads to fine focus on the bioburden target. Now the depth of focus is less than 1 micron, with step movement to find the best focus position now a fraction of a micron, say 0.3125 micron. This focus hunting is done over plus or minus 2.5 microns. Recall that the starting point for this fine focus hunt is derived from the seed position generated from the coarse focus.

For defining the best focus position in the microscope imaging module 62, the focus objective is moved in 0.3125-micron steps after coarse focus. Then for each focus position, the image intensity is measured and a software standard deviation is computed, using publicly available image standard deviation software, over a defined central segment of the image as described above. Maximum standard deviation defines the best focus. This amounts to the best contrast in the target image generating maximum standard deviation. Standard deviation in focus of the bioburden target of say 1 to 2 microns is a statistical value that is independent of gross intensity of the image. The microscope objective is moved to capture a specified number of images at different focus depths centered around the point of best focus.

Once the red light images are acquired, a computer turns off the red LED 66 and turns on a blue LED 68 of light source 72 at approximately 635 nm with a typical output power of 13 mW for further imaging using dichroic mirror 76. Use of dichroic mirrors 74 and 76 blocks illuminating reflected wavelengths. The camera, using a Sony progressive scan CMOS detector (Sony IMX249L4J-C) then captures nine further images, four on either side of the best focus. The images are transferred to the workflow manager 207 of FIG. 2. The workflow manager 207 sends instructions to the scan engine to position the sample to next point from the second data file to be directly under the objective of the microscope imaging module. The sequence of steps described above is repeated until images of all points of the second data file are captured. The workflow manager 207 passes the images in camera data block 201 and image management block 203, a database, to the GUI module 203 to be displayed as a database as well as for display by GUI 203 of likely bioburden fluorescent targets. While the first scan of the sample holder by the excitation module 11 is fast, the second scan by the microscope module 62 is slow because the field of view of the microscope is only about 200 microns and a membrane filter may be 25 mn, but appreciable speed is gained by locating probable bioburden targets before the second scan.

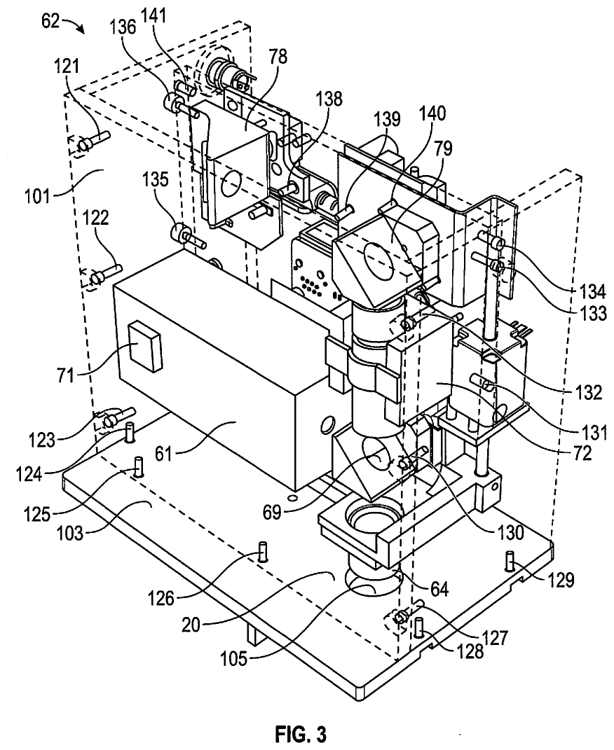

With reference to FIG. 3 base 103 of an instrument cabinet 101 is seen to support the microscope imaging module 62 with components corresponding to the same module in FIG. 1. The module is rigidly secured in place with fasteners 121-141. An adjacent laser fluorescence excitation module, also rigidly secured in place, is not seen. Microscope 61 shares a second optical axis, parallel to the first optical axis, via glass plate 69 observing a sample on a sample carrier 20 through aperture 105 and creating an image in camera 71 at the back of microscope 61. A power monitor 78 shares the second optical axis to adjust light output for sample observation. The microscope 61 may also have a rearward aperture, not shown for a human eye to view target samples.

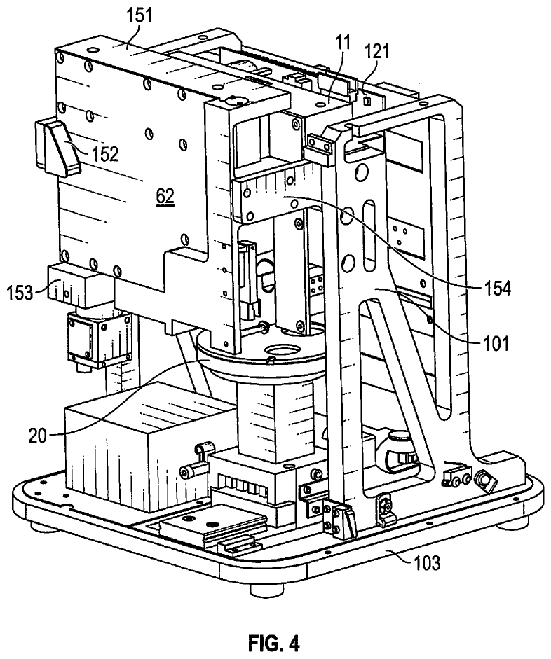

With reference to FIG. 4, base 103 is seen with microscope imaging module 62 secured in cabinet 101 with brackets 151, 152, 153, 154 and associated fasteners to secure rigidity. The second optical axis of the microscope imaging module 62 is directed onto the spinning sample carrier 20 of the type known from the '411 patent described below with reference to FIG. 9. The laser fluorescence excitation module 11, also rigidly secured in place, is adjacent to microscope imaging module 62 with a first optical axis, adjacent and parallel to the second optical axis, with both axes impinging on sample carrier 20, which both simultaneously rotates and translates, as explained, immediately below but not contacting modules 11 and 62. Cabinet 101 also supports a vertically mounted circuit board 121 that is adjacent to the fluorescent imaging module 11 and with a side of the board outwardly exposed for testing and inspection.

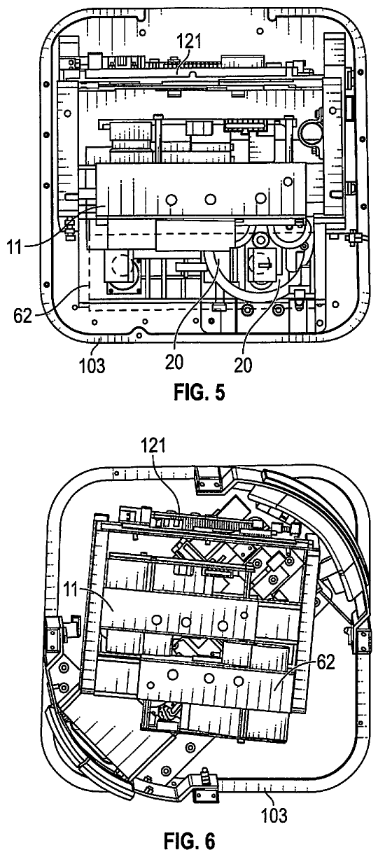

In FIG. 5, the second microscope imaging module 62 has been removed, indicated by dashed lines, to show the position of sample carrier 20 residing under both microscope module 62 and the fluorescence excitation module 11 in a position slightly spaced away from both modules by a few millimeters. Circuit board 121 is also seen. The circuit board carries the circuitry of FIG. 2. This includes a NUC microcontroller with ancillary circuits, such as memory for database storage and gate arrays programmed for sample spinner control, namely rotation and simultaneous advancement. Step motion is recorded where probable bioburden fluorescent events occur in order to go back to the event locations for microscope imaging. The enclosure is dark to prevent outside light from influencing the samples and observation of the samples.

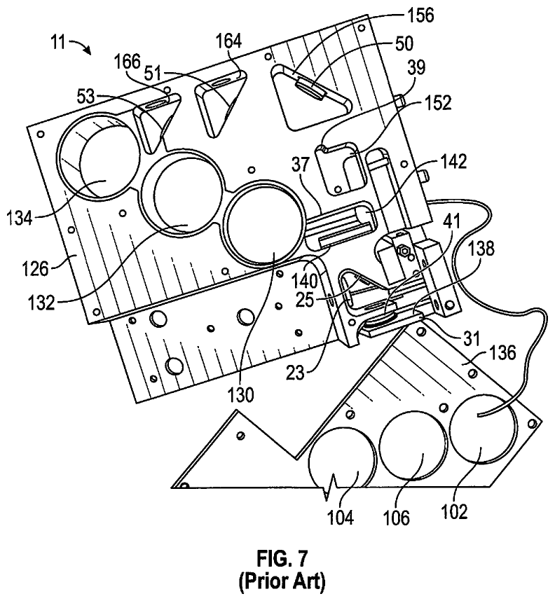

In FIG. 6, modules 11 and 62 are in place with both the fluorescent excitation module 11 and the microscope module 62 spaced apart from the sample carrier. Module can be removed from the top for maintenance and calibration but must be calibrated as to position on return so that axes are parallel. Similarly the electronics board 121 may easily be removed as a module.

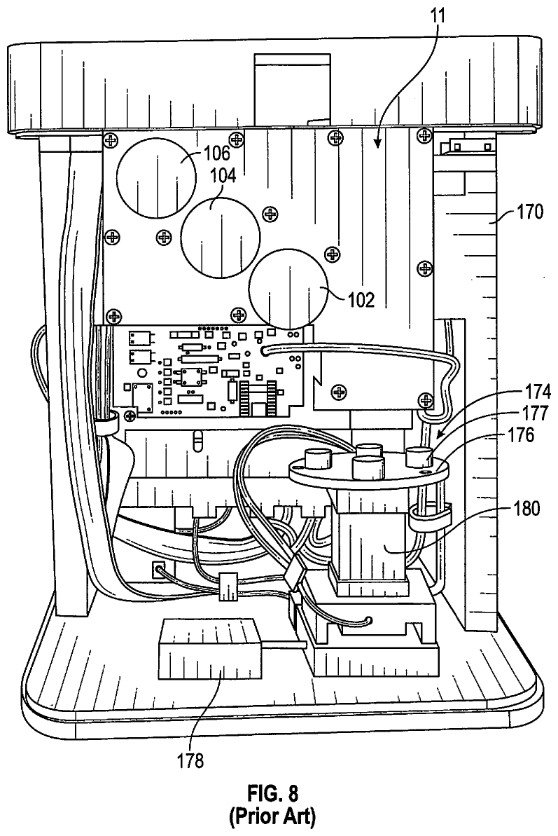

In FIG. 7 components of a fluorescence excitation module 11 are seen to have a mounting plate 126 with the PMT support holes 102, 106, 104 in a cover plate 136 that is removed. PMTs 43, 45, 47 of FIG. 1 fit into holes 130, 132, 134 mating with holes 104, 106, 102, respectively. The focusing lens 31 is shown movably secured to the base plate 126 for vertical focusing movement below pinhole 41. Laser rejection filter 37 for filtering the laser beam going into the system is shown secured vertically within a compartment 142 formed in the base plate 126.

The laser beam generated by the laser module subsystem (not shown here) can be directed through an aperture formed in the base plate 126 after which the laser beam is directed through the laser filter 23. In the same compartment, the beam splitter or glass plate 25 can be arranged which operates to reflect the laser beam downwardly onto the focusing lens 31, as well as transmitting the emitted fluorescent signal therethrough into the next compartment 142 by way of a further aperture formed in the base plate 126. Secured to a wall of compartment 142 is a laser rejection filter which only passes an entering emitted fluorescent signal while rejecting any laser light. The emitted fluorescent signal can then be directed through further apertures into a downstream compartment 152. A slot can be formed within a wall of compartment into which the collimating lens 39 is secured.

After passing through collimating lens 39, the emitted fluorescent signal can be reflected by folding mirror 50 arranged in compartment 156 in a direction toward the first beam splitter 51 and the second beam splitter 53 through corresponding apertures in the base plate 126. The first beam splitter 51 can be secured in compartment 164 and includes apertures which allow any reflected emitted fluorescent signal to be reflected downwardly to the first PMT in support hole 104. The second beam splitter 162 can be secured in compartment 166 and can include apertures which allow any reflected emitted fluorescent signal to be reflected downwardly to the second PMT in support hole 106. An additional aperture can be provided in compartment 166 which allows any emitted fluorescent signal not reflected by either beam splitters 51, 53 to be directed toward third PMT in support hole 102. The recorded fluorescent spectrum assists in later analysis in the microscope module to characterize target substances, eliminating false positives.

In FIG. 8 a housing for the modules 11 and 62 of FIG. 1 is shown. The module 11 is seen to rigidly reside in a cabinet 170, wherein the bioburden test apparatus is useful as a tabletop unit. For example, the dimensions of the cabinet 170 can be about 10 inches; wide, by about 10 inches; deep, by about 12 inches; high. The cabinet 170 can include a door, now shown, which can be opened and closed to allow user access to the sample assembly 174 on a rotating carousel that can be advanced by a linear stage. Access to the sample assembly 174 allows a user to insert, remove, and/or replace sample holder 176. The sample holder 176 uses magnets to seat a substrate that supports a filter in a circular holder 177. The movement of the sample assembly is controlled by a rotary stepper motor 180 and a linear stage stepper motor 178 to effect translation of the sample assembly in a linear trajectory as the sample holder traces an arcuate trajectory beneath a beam.

In FIG. 9 a typical use scenario, as described in U.S. Pat. No. 9,669,406, assigned to Reametrix, Inc. (assignee herein), a sample carrier 174 with membrane filters 422, 424, 426 carrying target material are loaded onto the moveable holder support 410, which is in turn loaded onto the lower movable platform 411. Magnetic fasteners 432, 434, and 436 are used to secure the filters in place. A stepper motor 401 moves platform 411 carrying the rotary stepper motor 180. Linear stepper motor 401 has an arm for moving the movable platform 411 in a linear trajectory on a track 414 on base 103. Rotary stepper motor 180 moves the sample assembly in a rotational trajectory, shown by arrow 416 and linear stepper motor 401 moves the sample assembly in a linear trajectory shown by arrow 418. All the components are locked into place, and now form a single unit. Then, when the movable platform moves, the entire sample assembly moves and the sample holder rotates yielding spiral scans as described above. When an incident beam 316 is allowed to impinge on the sample, the movement of the sample assembly causes different portions of the sample to be illuminated by the incident beam, giving rise to space dependent fluorescence signals. It is also important that the individual components, namely the sample carrier with filter, the sample holder and the movable platform are secured so that when the movable platform is moving in a suitable trajectory, there is no wobble or shake of the sample carrier within the receptacle or shake of the modules.

The stepper motor used to control the movable platform may be a combination of linear stage stepper motor and a rotary stepper motor. The stepper motors may be controlled using a field programmable gate array (FPGA) as part of motion control electronics 201 of FIG. 2. The rotary stepper motor 412 rotates the sample assembly at a constant rotational speed. The linear stage stepper motor can be arranged to continuously move the rotating sample assembly linearly during measurement resulting in helical scans of the entire surface of the sample.

An integrated, protected dual W-bridge power supply with external components and logic can be implemented to regulate the current precisely to the stepper motors. In the design of the present teachings, no heat-sinking or active cooling is required at the expected ambient conditions. A look-up table of an FPGA can be connected to power drivers which operate to regulate motor current values.

An encoder can be connected to the rotary stage stepper motor. By using position data from the encoder, or the frequency of the encoder signal, the angular position of the rotary motor may be tracked to ensure that the rotary motor is rotating at a constant velocity. In addition, the encoder position can also be used to monitor the motor position during starting and stopping conditions.

Since it is impossible to create sample carriers which are perfectly flat, especially at the desired low-unit costs of sample carriers, it is possible to provide compensation for any such imperfections when conducting a rotary scan using autofocus techniques described above.

In summary when a laser spot along a first optical axis is focused at r,θ,Z coordinates of a fluorescent target for target excitation, the fluorophores in the sample volume, for example fluorescent tags on target molecules, are excited giving rise to one or more fluorescence signals. The fluorescence signals pass through a pinhole that restricts the light emitted from the beam spot to a particular depth and volume. These restricted signals from the sample volume can define the exact Z coordinate. The fluorescence of a probable bioburden target is characterized by a suitable fluorescence detector. While, the choice of wavelengths of fluorescence signals allows the use of sample carriers that are made of plastic, which are significantly less expensive than those made of glass or other materials, false positives arise from the plastic materials.

The method then involves moving at least one of the sample carrier or the light source or both relative to each other to scan the sample. The movement is preferably an R-θ motion combined with linear advancement to achieve a spiral scan of the sample. In one embodiment, the light source is held stationary perpendicular to a sample carrier having a horizontal surface while the sample carrier is moved rotationally and linearly relative to the light source. Since the light source is stationary, a spiral scan of the sample carrier is achieved as the sample carrier is rotated in the horizontal plane, giving rise to an R-θ scan. The relative movement of the light source and the sample carrier is coordinated to achieve a complete scan of the R-θ plane at a selected Z-depth, to establish r,θ,Z coordinates.

When a sample comprising at least one fluorophore is present in a sample carrier, that particular region emits higher levels of fluorescence signals relative to other regions of the sample carrier. The location of all probable targets are mapped in an R-θ plane. At the same time background characterizes bulk fluorescence of the sample selection. It is important to know the bulk measurement for target discrimination.

In one exemplary embodiment, for a given dimension of the sample carrier and the focus diameter, the R-θ scan is conducted in a spiral scan at a θ resolution of about 50,000 pixels per revolution and encompasses about a 2.5 mm wide scan within a 3 mm wide channel to accommodate a positional error of about 0.25 mm at about 5 micron spatial resolution at the sample plane, resulting in 500 scan lines. Preferably 50% overlap should be provided between adjacent scan lines. After detecting the one or more fluorescence signals, probable targets are determined and are mapped.

As noted herein, the R-θ scan is used to find an area of interest where collected fluorescent light exceeds a calibrated threshold level. Normalized bulk or background fluorescence measurement of the sample is completed. Fluorophores may be distributed throughout the sample carrier. However, wherever a target analyte is present, the concentration of fluorophores in that region will be greater than the remaining regions. It was observed that the optical plane scan of the individual areas of interest in a sample carrier gives rise to a distribution of emitted fluorescent signals based on the presence or absence of analytes plus spurious fluorescent particles. The distribution of emitted fluorescence signals is typically a Gaussian distribution. A method involves processing the emitted fluorescence signals from the individual areas of interest using a Gaussian curve-fitting method for each cross-section for a target location of interest. The processed data in the exemplary embodiment represents Gaussian-fitted intensity maximum as a function of theta, width of the Gaussian maximum (i.e. the measure of the capillary thickness) to find high probability targets of interest.

In the exemplary embodiment, during an R-θ-Z scan the data processing can include: generation of one R-θ image from a single scan or stitching together multiple R-θ scans, determination of the local background through pixel window spatial averaging to smooth out the effects of noise and events; subtraction of the background plus a noise floor to highlight events; using matched filter convolution to detect events; establishing Z coordinate, fitting a 2-D Gaussian function to characterize the events; and generating a location table for high probability targets that are expected to be rare when testing for sterility. At the end of any one the scanning sequences or all of the scanning sequences, application-specific image processing software can be used to stitch or knit together all of the rotational passes over the sample to produce a final three-dimensional sample data image map showing locations of high probability targets in a data file. For each located target, with specified r,θ,Z coordinates, the spin table or chuck carrying the sample holder is rotated by a fixed angle, say 40 degrees, for a microscope probing and recording with a camera on a second optical axis parallel to and adjacent to the first optical axes. The target is illuminated with a red LED for focus and then with a blue LED to stimulate fluorescence. The target is characterized by using the microscope, either by a human or by artificial intelligence. For example, artificial intelligence could look for straight lines in a target that would indicate a plastic particle, whole curved lines indicate a probable bacterium. A human would be able to identify particular bacteria, then return the spin chuck to the prior r,θ coordinate to repeat the process for each fluorescent event.

In general, the above described method provides high-sensitivity fluorescence measurements from relatively small samples having rare bioburden specimens. These attributes render the method of the invention to be adapted for use to verify sterility of fluids in a two-step process of obtaining locations of tagged fluorescent targets and using a microscope to eliminate false positives.

Thus, the method for measuring fluorescence as described herein advantageously provides for the simultaneous detection of normalized bulk fluorescence, event fluorescence for the sample, and detection of bioburden.

What is claimed is:

1. A modular bioburden test instrument comprising:
a moveable sample carrier with fluorescent target samples in fixed positions;
a fluorescence excitation module having a first optical axis with light beam along the first optical axis impinging on the fluorescent target samples when the target samples move beneath the beam exciting fluorescence in the target samples;
a microscope module having a second optical axis parallel and adjacent to the first optical axis with a microscope on the second axis for observing the excited fluorescent target samples, the microscope module having a first light source at a first wavelength on the second optical axis for microscope focus on the sample without photo bleaching and a second wavelength on the second optical axis to stimulate sample fluorescence.

2. The apparatus of claim 1 wherein the fluorescence excitation module has optical components substantially as described in U.S. Pat. No. 9,523,640.

3. The apparatus of claim 1 wherein the moveable sample carrier is constructed substantially as described in U.S. Pat. No. 9,669,406.

4. The apparatus of claim 1 wherein the microscope has a camera disposed on the second axis recording images fluorescent targets.

5. The apparatus of claim 1 further comprising a modular circuit board with electronic controls for the fluorescent excitation module, the microscope module and the moveable sample carrier.

6. The apparatus of claim 5 further comprising a housing for removably seating the modular circuit board, the fluorescent excitation module and the microscope module.

7. The apparatus of claim 6 wherein the movable sample carrier resides beneath the modular circuit board and the fluorescent excitation module with both the first and second optical axes perpendicular to the sample carrier.

8. The apparatus of claim 7 wherein the movable sample carrier carries fluorescent targets on filter membranes.

9. The apparatus of claim 8 wherein the filter membranes rotate on a spinner.

10. The apparatus of claim 7 wherein the movable sample carrier carries microfluidic passages for tagging targets to create fluorescent targets.

11. Apparatus for testing bioburden on filter membranes and the like comprising:
a movable sample holder holding membranes with fluorescent targets in a plane;
a fluorescent excitation module having a beam directed along a first optical axis perpendicular to said sample holder and exciting fluorescence among in probable bioburden targets in the membranes; and
a microscope module having a camera viewing a second optical axis parallel and closely spaced to the first optical axis, with viewing of the probable bioburden targets in the membrane to confirm or reject bioburden therein, the microscope module having a first light source at a first wavelength on the second optical axis for microscope focus on the sample without photo bleaching and a second wavelength on the second optical axis to stimulate sample fluorescence.

12. The apparatus of claim 11 wherein the camera is a CCD chip.

13. The apparatus of claim 11 wherein the sample holder, fluorescent excitation module and microscope module are all housed in a cabinet.

14. The apparatus of claim 13 wherein the fluorescent excitation module and microscope module are in twin boxes above the sample holder that are removable from said cabinet.

15. The apparatus of claim 14 wherein an electronics board is mounted in the cabinet alongside said twin boxes.

16. The apparatus of claim 11 wherein the microscope module includes red and blue LEDs directing beams along the second optical axis onto the sample holder.

17. A method for testing bioburden on filter membranes comprising:
rotating a sample holder holding membranes with fluorescent targets in a plane;
exciting and detecting fluorescence in the fluorescent targets with a beam directed along a first optical axis perpendicular to the sample holder plane and impinging on the fluorescent targets while the sample holder is rotating;
recording positions of probable bioburden in the fluorescent targets;
rotating the fluorescent targets to a second optical axis parallel to the first optical axis and illuminating the targets with a first optical wavelength for focus on the targets without photo bleaching and with a second wavelength stimulating fluorescence in the target; and
observing the probable bioburden to confirm or reject bioburden in the fluorescent targets.

18. The method of claim 17 further defined by advancing the sample holder during rotation.

19. The method of claim 17 further defined by determining probable bioburden by fluorescent spectra excited on the first optical axis during said recording of positions.

20. The method of claim 17 further defined by providing a camera on the second optical axis for observing probable bioburden.
